(19) United States
(12) Patent Application Publication
(10) Pub. No.: US 2012/0258230 A1
(43) Pub. Date: Oct. 11, 2012

(54) THICKENING AND EMULSIFYING GUAR GUM AND GUAR BLENDS CONJUGATED WITH ENDOGENOUS AND EXOGENOUS PROTEINS

(75) Inventor: Marceliano B. Nieto, Abington, MD (US)

(73) Assignee: TIC GUMS, INC., Belcamp, MD (US)

(21) Appl. No.: 13/442,481

(22) Filed: Apr. 9, 2012

Related U.S. Application Data
(60) Provisional application No. 61/473,404, filed on Apr. 8, 2011.

(51) Int. Cl. A23J 1/14; A23J 1/08; A23L 1/03; A23L 1/0526; A23J 1/20

(52) U.S. Cl. 426/583; 426/654; 426/580; 426/650

(57) ABSTRACT

The invention relates generally to gum-protein conjugates, as an alternative to substances such as propylene glycol alginate [PGA], wherein the conjugate both thickens and emulsifies. Exemplary uses include use in food emulsions, cosmetics, and industrial applications. For example, one aspect of the present invention relates to gum-protein conjugates capable of acting as both thickeners and emulsifiers and methods of making the same. Certain embodiments of the conjugation processes use guar gum in its milled, powdered form or as obtained from guar splits as the viscous substrate and conjugates the guar gum with a protein that is either endogenous or exogenous. Another embodiment of the present invention uses exogenous protein, or protein that is not part of guar seeds, as the conjugating protein. In this embodiment, guar gum is conjugated with protein having a globular and flexible structure, to produce a conjugate that both thickens and emulsifies.

### CROSS-REFERENCE TO RELATED APPLICATIONS

This application claims priority to U.S. Provisional Patent Application No. 61/473,404, filed Apr. 8, 2011, which is incorporated herein in its entirety.

### BACKGROUND OF THE INVENTION

1. Field of the Invention

The invention relates generally to a gum-protein conjugate as an alternative to propylene glycol alginate [PGA], which both thickens and emulsifies for use in food emulsions, cosmetics and industrial applications.

2. Background

A gum that can both thicken and emulsify is rare in the market and currently only propylene glycol alginate (“PGA”) fits this definition. As noted below, the prior art discloses conjugating a non-viscous gum or blend of polysaccharides and a protein to produce an emulsifier. While such products can work in some emulsion applications, they still require a thickener to stabilize many emulsified products such as salad dressings, dips, soups and sauces to increase viscosity, and reduce oil and water movement. The following references describe these and similar products.

U.S. Pat. No. 5,591,473 entitled “Protein-Polysaccharide Complex Composition, Method and Preparation of Use” discloses a protein-polysaccharide complex of a substantially water insoluble protein, such as prolamine, and a polysaccharide, such as guar gum or gum arabic or other complex plant exudate polysaccharides, where the polysaccharide comprises 90% to 99.5% by weight of the total complex.

U.S. Pat. No. 5,645,880 entitled “Protein-Polysaccharide Complex Composition and Method of Use” discloses a food preservative comprising a stabilizing acid and a protein-polysaccharide complex. The complex comprises a substantially water-insoluble protein, such as a prolamine, and a water-soluble polysaccharide, such as guar gum or gum arabic.

U.S. Pat. No. 6,106,828 entitled “Conjugation of Polypeptides” discloses a polypeptide conjugate used to reduce allergenicity of industrial products. The conjugate comprises a polymeric carrier molecule, such as carboxymethylcellulose, guar gum, alginic acid, etc., coupled to two or more polypeptide molecules, especially polypeptide molecules having enzymatic activity.

U.S. Pat. No. 6,956,119 entitled “Polysaccharide-Protein Conjugate” discloses a method for producing a polysaccharide-polypeptide conjugate by reacting at least one antigenic polypeptide with a partially oxidized polysaccharide carrier.

U.S. Pat. No. 7,601,381 entitled “Polysaccharide and Protein Conjugate, and Emulsifiers and Emulsions Containing It” describes an emulsifying agent composed of soybean protein and soybean polysaccharides.

U.S. Pat. No. 6,225,462 entitled “Conjugated Polysaccharide Fabric Detergent and Conditioning Products” discloses a laundry detergent product comprising a polysaccharide with a 1-4 linked glycan backbone structure conjugated to a protein which is an enzyme, antibody or antibody fragment.

U.S. Patent Application No. 2008/0241320 entitled “Protective Hydrocolloids for Active Ingredients” discloses both a composition comprising a rice endosperm protein partially conjugated with mono-, di-, or oligosaccharides and a fat-soluble active ingredient, as well as, an associated method for making the composition.

U.S. Patent Application No. 2009/0311407 entitled “Production of Protein-Polysaccharide Conjugates” describes a protein-polysaccharide conjugate created by reacting a polysaccharide containing a reducing sugar and a protein in an aqueous solution under specific temperature conditions. The solution comprises 10%-40% by weight polysaccharide and 1%-30% by weight of protein.

U.S. Patent Application No. 2008/0299281 entitled “Emulsifiers and Emulsions” describes a protein-polysaccharide conjugate derived from whey protein and a non-ionic polysaccharide that acts as an emulsifier. An associated process for making said emulsifier is also disclosed.

U.S. Patent Application No. 2010/0098827 entitled “Modified Protein-Based Low-Carbohydrate Food Ingredient and Process for Making Same” discloses a modified protein-carbohydrate conjugate that has a viscosity of at least 1.0 Pa-s at a shear rate of 50 s⁻¹ at 25° C., and a creaming index of less than 25%, as well as, a process for producing the complex.

There are also published works discussing the conjugation of a polysaccharide with a protein.

The conjugation of sodium caseinate and gum arabic catalyzed by transglutaminase was published in J. Agric. Food Chem., 2006, 54 (19): 7305-7310. The extent of conjugation was monitored by size exclusion separation coupled with a multi-angle laser light scattering detector where the molecular masses of the conjugates increased from ˜50 kDa to 1600 kDa. This method of protein-polysaccharide conjugation offered noticeable advantages over previously used methods, and the conjugates exhibited unique functional properties.

The kinetics of formation and functional properties of conjugates prepared by dry-state incubation of beta-lactoglobulin/acacia gum electrostatic complexes was published in J. Agric. Food Chem., 2005 Nov. 16; 53 (23): 9089-9099. Complexes were formed at pH 4.2 upon dry-state incubation for up to 14 days at 60° C. and 79% RH. SDS-PAGE electrophoresis with silver staining confirmed the formation of β-lactoglobulin/acacia gum conjugates. The conjugates exhibited higher foam capacity than the incubated protein, as well as, lower equilibrium air/water surface tension.

Finally, a study entitled “Whey protein-maltodextrin conjugates as emulsifying agents: An alternative to gum arabic” was published in Food Hydrocolloids (2007), 21(4): 607-616. This study investigated the conjugates under both acidic and high electrolyte concentration conditions in systems containing medium-chain triglyceride oil or orange oil. Covalent coupling of protein to polysaccharide was achieved by dry-heat treatment of a protein and polysaccharide mixture for up to two hours. A whey protein-maltodextrin conjugate (WP-MD19) made from maltodextrin (Dextrose Equivalent=19) of intermediate mean molecular weight (8.7 kDa) was found to be capable of producing fine emulsion droplets (0.5 μm-1 μm) with either triglyceride oil or orange oil.

### BRIEF DESCRIPTION OF THE DRAWINGS

FIG. 1 shows a model salad dressing emulsion test comparing the thickening and emulsification properties of a salad dressing containing: 1A—guar gum-guar bran protein conjugate of the present invention, 1B—salad dressing containing PGA and 1C—salad dressing containing non-conjugated guar gum, as a control.

FIG. 2 shows salad dressing emulsions containing poorly conjugated gum blends using gum and octenylsuccinic acid anhydride.

FIG. 3 shows salad dressing emulsions containing guar gum-guar protein conjugates created at different reaction temperatures. 3A—175° F.; 3B—185° F.; 3C—190° F.

FIG. 4 shows salad dressing emulsions containing: 4A—control PGA emulsion, 4B—guar gum-whey protein conjugates, 4C—guar gum-guar protein conjugates and 4D—guar blends (guar-inulin-maltodextrin)-guar protein conjugates, showing good emulsification.

### SUMMARY OF THE INVENTION

It is an aspect of the present invention to produce gum-protein conjugates capable of acting as both thickeners and emulsifiers. Conjugates are generally known in the art as substances that are formed when two compounds are chemically combined. Certain embodiments of the conjugation processes described herein uses guar gum in its milled, powdered form or as obtained from guar splits (as described below) as the viscous substrate and conjugates the guar gum with a protein that is either endogenous (originating from the guar seeds itself) or exogenous (of non-guar origin).

For example, a first embodiment of the present invention uses endogenous guar proteins as the conjugating proteins, which endogenous proteins are obtained from the guar seed itself. After dehusking and milling, the guar seed yields two fractions: the bran (ground germ and husk) and the endosperm. Guar gum is derived from the endosperm, while the guar bran contains the endogenous proteins used in the first embodiment of the present invention. Roughly, 100 kg of dried guar seeds yields 50 kg of endosperm or guar gum, and 50 kg of guar bran, which guar bran is composed of approximately 25 kg endogenous proteins and 25 kg husk and other insoluble materials. In this first embodiment, gum-protein conjugates that both thicken and emulsify comprise between 1% and 25% endogenous guar protein, which protein is obtained by dissolving the guar bran obtained after dehusking the guar seeds and which protein is unrefined and not further treated (i.e., “as is” basis), conjugated with milled, powdered guar gum.

One preferred method for producing such conjugates may be obtained by performing the following steps:
i) Mixing 2%-50% guar bran by weight in water, which guar bran comprises guar proteins and insoluble materials in approximately equal amounts, at a temperature of between room temperature (68° F.-77° F.) and 200° F., said mixture containing approximately 1%-25% guar proteins by weight, and then filtering the insoluble materials using a 40-80 mesh screen (e.g., a mesh screen containing 0.22 mm-0.33 mm openings) or other suitable screen to obtain a filtered guar bran solution;
ii) Adding between 1 and 10% powdered, milled guar gum by weight to the filtered guar bran solution and adjusting the pH to between 8.0 and 12.0 with caustic soda or another alkali, thereby forming a slurry;
iii) Heating the slurry to a temperature of between 140° F. and 212° F. for a period of between 15 minutes and 4 hours, during which time the guar gum reacts with the guar proteins, then adding an acid to neutralize the alkali, as needed;
iv) Drying the slurry using a drum dryer, a film casting line or other suitable dryer, thereby forming a dried product;
v) As needed, additionally heating the dried product at a temperature of between 200° F. and 310° F. for 5 minutes to 2 hours to allow additional conjugation to occur; and
vi) Milling the conjugate to a desired mesh quality or granularity, i.e., coarse mesh, standard mesh or fine mesh, based on a customer's needs.

In addition, guar gum obtained from guar splits may be used instead of milled, powdered guar gum. Guar splits are created when the guar seed, which is dicotyledon in nature—meaning it is composed of two cotyledons attached at one end of the seed—splits into two during dehusking.

In one method, the following step may replace step ii) above:
ii) Adding between 1% and 10% by weight guar splits to the filtered solution, which guar splits have first been soaked in water so as to become swollen (i.e., larger in volume and softer, but not dissolved) and then chopped in a blender or other suitable comminuting device, and adjusting the pH of the resulting solution to between 8.0 and 12.0 with caustic soda or another alkali, thereby forming a slurry.
   A further embodiment of the present invention uses exogenous protein, or protein that is not part of guar seeds, as the conjugating protein. In this embodiment, guar gum is conjugated with protein having a globular and flexible structure, such as, whey protein, sodium caseinate, egg protein or β-lactoglobulin, to produce a conjugate that both thickens and emulsifies.

One preferred process of producing such conjugates may include the following steps:
i) Mixing 1%-25% proteins by weight in water at a temperature of between approximately room temperature (68° F.-77° F.) and 200° F. for at least 15 minutes, thereby forming a solution, wherein said proteins have a globular and flexible structure;
ii) Adding between 1% and 10% powdered, milled guar gum to the solution and adjusting the pH to between 8.0 and 12.0 with caustic soda or another alkali, thereby forming a slurry;
iii) Heating the slurry to a temperature of between 140° F. and 212° F. for a period of 15 minutes to 4 hours, during which time the guar gum reacts with the proteins, then adding an acid to neutralize the alkali, as needed;
iv) Drying the slurry using a drum dryer, a film casting line or other suitable dryer, thereby forming a dried product;
v) As needed, additionally heating the dried product at a temperature of between 200° F. and 310° F. for 5 minutes to 2 hours to allow additional conjugation to occur; and
vi) Milling the conjugate to the desired mesh quality or granularity based on a customer's needs.

As with other embodiments, guar gum from guar splits may be used instead of powdered, milled guar gum so long as a similar procedure is followed as that discussed above (but, of course, replacing references to “guar bran protein” with the exogenous proteins of this embodiment).

Following these procedures, it is possible to obtain gum-protein conjugates having thickening and emulsifying properties, including, but not limited to, guar gum-guar bran protein conjugates and guar gum-exogenous protein conjugates. In one example, adjusting the pH of the guar gum/guar protein solution to between about 8.0 and about 12.0 was found to decrease conjugation time and make the conjugation process more cost effective. Indeed, in some instances, an acidic environment (i.e., pH of 2.0-3.5) resulted in unsuccessful conjugation. While it is generally known in the art that high pH values can decrease conjugation time, it was unexpected that a very basic solution could be used in the conjugation reaction described herein; as such environments can damage both proteins and guar gum.

The efficacy of the conjugates created via the exemplary conjugation processes described above has been confirmed via a model salad dressing emulsion test, wherein the gum conjugates of the present invention were added to a salad dressing and the resulting mixture was observed to determine, among other things, if separation occurred. To create the exemplary salad dressing used for observation, the following procedure was performed using the values set forth in Table 1.

TABLE 1
Salad Dressing Emulsion Test Ingredients

| Ingredients | % | Grams |
|---|---|---|
| Water | 24.037 | 94.92 |
| Potassium sorbate | 0.1 | 0.4 |
| Vinegar | 8.345 | 33.38 |
| Soybean oil | 36.103 | 144.412 |
| Salt | 2.253 | 9.012 |
| Gum Conjugate | 0.615 | 2.46 |
| HFCS | 28.547 | 114.188 |
| Thickener, as needed | 0.3 | 1.23 |

First, water and high fructose corn syrup were weighed separately. Potassium sorbate was then added to the water and mixed until dissolved. Next, one of the gum conjugates of the present invention was added to the water/potassium sorbate mixture and mixed for 10 minutes. Salt was then added to the high fructose corn syrup and mixed for three minutes. Finally, the water/potassium sorbate/gum solution and the high fructose corn syrup/salt solution were mixed together for one minute, thereby forming the salad dressing used for observation and testing.

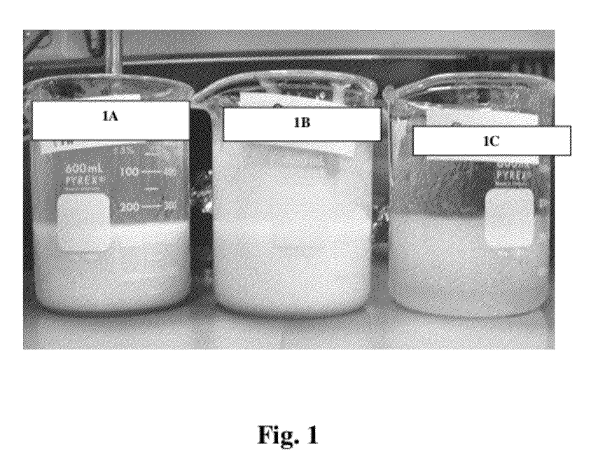

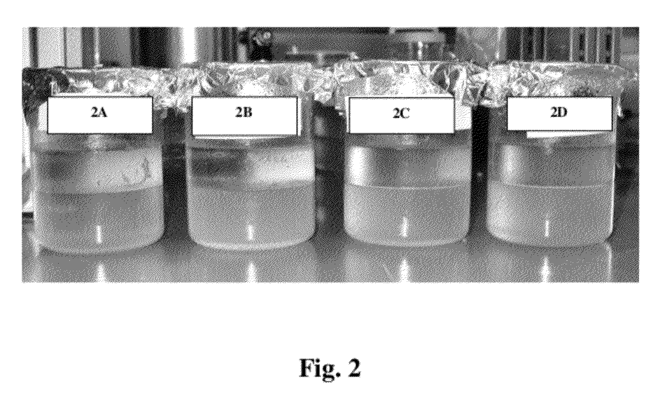

Test results (see FIGS. 1-4 and Table 2) show the exemplary conjugates may have both thickening and emulsifying effects. Indeed, as shown in FIG. 1A and Table 2, the conjugates showed both emulsifying and thickening similar to a PGA control, while non-conjugated guar gum (FIG. 1C and Table 2) only showed thickening without any associated emulsifying (i.e., the salad dressing separated). FIGS. 2A to 2D, by contrast, show a failed conjugation process of substrates that were thin (low viscosity) where the emulsion completely separated in water and oil layers. The conjugation process depicted in these FIGS. 2A-2D used octenylsuccinic acid anhydride, another common conjugating chemical used with gums, instead of proteins. Although these conjugates did not include any protein, these figures are representative of how an emulsion would appear if there is no thickening and emulsifying, and should be considered for comparative purposes only. Indeed, gum-protein conjugates that have a thin or low viscosity will similarly cause the salad dressing to separate due to a lack of stabilization or thickening that prevents oil from rising to the surface of the dressing.

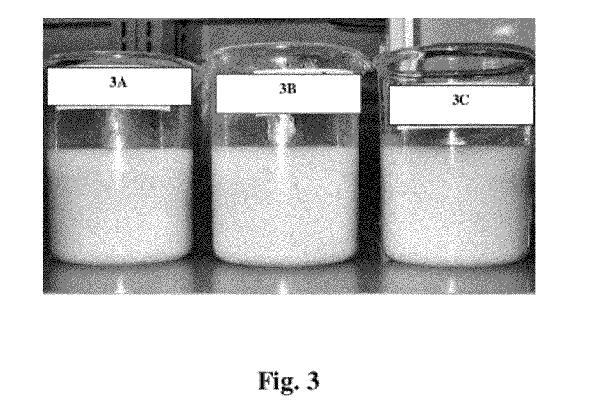

FIGS. 3A-3C show stable salad dressing emulsions (i.e., salad dressing emulsions that do not separate for at least a week after formation) containing exemplary conjugates. In this example, the conjugates were reacted at reaction temperatures of about 175° F., 185° F. and 190° F. for one hour at pH of ˜10.0. The fact that all of these emulsions were stable shows that conjugation at these different reaction temperatures was successful, which further suggests that other temperatures—lower and higher than these—combined with different pH values and different reaction times, would work as well.

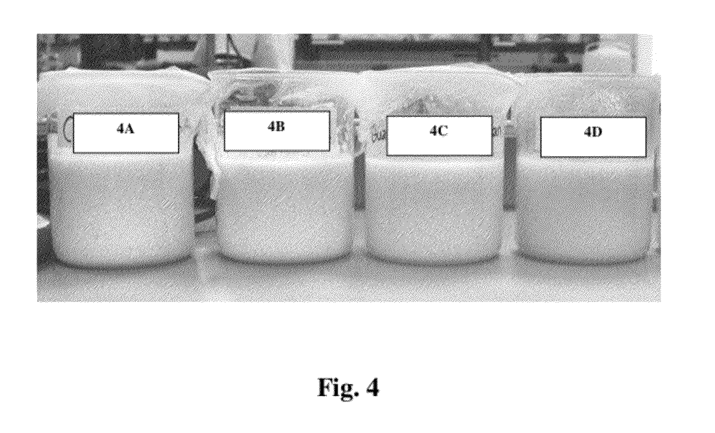

FIG. 4D shows, via the stability of the salad dressing emulsions depicted therein, successful conjugation of guar blends consisting of guar gum, inulin, and maltodextrin with guar bran protein, which resulting conjugate showed both thickening and emulsification properties. FIG. 4B similarly shows successful conjugation between guar gum and whey protein, with the resulting conjugate again showing both thickening and emulsifying capabilities. FIG. 4A shows another control PGA salad dressing and FIG. 4C depicts another successful repeat of a guar gum-guar protein conjugate of the present invention.

An attempt to conjugate guar gum and gelatin was unsuccessful. Given that gelatin is a fibrous structural protein and quite inflexible, whereas whey protein is globular and flexible, this suggests that, to a certain degree, proteins that are both globular and flexible help to give the conjugate a good emulsifying property.

TABLE 2

| | Viscosity, | | Shown in |
|---|---|---|---|
| Sample/Treatment | cP | Storage Stability | Picture |
| Guar FF 4000 [Thickener only Control] | 6190 | Separated | FIG. 1C |
| | | overnight | |
| PGA [Thickener-Emulsifier Control] | 6000 | Stable for >3 | FIG. 1B & |
| | | months | FIG. 4A |
| No Thickener, Poor Emulsifier | — | Separated | FIG. 2A-2D |
| | | immediately | |
| Guar-Guar Bran Conjugate, heated to 185° F. | 6820 | Stable for >3 | FIG. 1A |
| during caustic reaction [pH 9.5-10] for | | months | |
| 1 hour; oven heated 1 hour at 200° F.; | | | |
| Trial 1 Guar-Guar Bran Conjugate, heated | 6320 | Stable for >3 | FIG. 3B |
| to 185° F. during caustic reaction [pH 9.5- | | months | |
| 10] for 1 hour, not oven heated | | | |
| Trial 2 Guar-Guar Bran Conjugate, heated | 6370 | Stable for >3 | FIG. 3B |
| to 185° F. during caustic reaction [pH 9.5- | | months | |
| 10] for 1 hour, not oven heated | | | |
| Trial 3 Guar-Guar Bran Conjugate, heated | 6130 | Stable for >3 | FIG. 3B |
| to 185° F. during caustic reaction [pH 9.5- | | months | |
| 10] for 1 hour, not oven heated | | | |
| Guar-Guar Bran Conjugate, heated to 175° F. | 7200 | Stable for >3 | FIG. 3A |
| during caustic reaction [pH 9.5-10] for | | months | |
| 1 hour, not oven heated | | | |
| Guar-Guar Bran Conjugate, heated to 190° F. | 8670 | Stable for >3 | FIG. 3C |
| during caustic reaction [pH 9.5-10] for | | months | |
| 1 hour, not oven heated | | | |
| Guar-Whey Protein Conjugate, heated to | 10,260 | Stable for >1 | FIG. 4B |
| 185° F. during caustic reaction [pH 9.5-10] | | month | |
| for 1 hour, not oven heated | | | |

Although the disclosure has been described and illustrated with a certain degree of particularity, it is understood that the disclosure has been made only by way of example, and that numerous changes in the condition and order of steps can be resorted to by those skilled in the art without departing from the spirit and scope of the disclosure.

What is claimed is:

1. A process for producing a gum-protein conjugate comprising the steps of:
a) mixing a protein between 1% and 25% by weight in water at a temperature of between approximately 68° F. and 200° F. to form a first solution;
b) adding guar gum between 1% and 10% by weight to the first solution, thereby forming a second solution;
c) adding an alkali to adjust pH of the second solution to between pH 8.0 and 12.0;
d) heating the second solution to a temperature of between 140° F. and 212° F. for a period of between 15 minutes and 4 hours;
e) drying the second solution, thereby forming a dried product; and
f) milling the dried product to a desired mesh quality.

2. The process of claim 1 wherein the drying the second solution is step e) is drying with a slurry dryer.

3. The process of claim 1 wherein the protein between 1% and 25% by weight is guar bran between 1% and 25% by weight, which guar bran is composed of approximately equal parts proteins and insoluble materials, and further comprising a step of using a filtering device to remove the insoluble materials.

4. The process of claim 4 wherein the filtering device is a screen between 40 mesh and 80 mesh.

5. The process of claim 1 wherein the guar gum is obtained by soaking guar splits in water until swollen, and then chopping the guar splits.

6. The process of claim 5 wherein the chopping of the guar splits is with a comminuting device.

8. The process of claim 1 wherein the guar gum is powdered milled guar gum.

9. The process of claim 1 wherein the protein is an exogenous protein with a globular and flexible structure.

10. The process of claim 9 wherein the exogenous protein is selected from the group consisting of whey protein, sodium caseinate, egg protein and β-lactoglobulin.

11. The process of claim 1 wherein the dried product is a gum-protein conjugate.

12. The process of claim 1 wherein the gum-protein conjugate is guar gum conjugated with guar bran protein.

13. The process of claim 1 wherein the gum-protein conjugate is guar gum conjugated with an exogenous protein.

14. The process of claim 13 wherein the exogenous protein is selected from the group consisting of whey protein, sodium caseinate, egg protein and β-lactoglobulin.

15. The process of claim 1 further comprising adding an acid to the second solution after step d) to neutralize the alkali.

16. The process of claim 1 further comprising heating the dried product after step e) at a temperature of between 200° F. and 310° F. for a time period of between 5 minutes and 2 hours.

17. A gum-protein conjugate produced by the process of claim 1.

18. The gum-protein conjugate of claim 13, wherein said gum-protein conjugate is both a thickener and emulsifier.
